(19) United States
(12) Patent Application Publication
(10) Pub. No.: US 2023/0421435 A1
(43) Pub. Date: Dec. 28, 2023

(54) Configuration and Commission of a Building

(71) Applicant: Siemens Schweiz AG, Zürich (CH)

(72) Inventors: Andreas Vogt, Luzern (CH); Franz Renggli, Rothenburg (CH); Heinrich Kränzlin-Meier, Feusisberg (CH); Beat Kyburz, Ottenbach (CH)

(73) Assignee: Siemens Schweiz AG, Zürich (CH)

(21) Appl. No.: 18/253,018

(22) PCT Filed: Jun. 17, 2021
(86) PCT No.: PCT/EP2021/066347

§ 371 Date: May 15, 2023

(30) Foreign Application Priority Data
Nov. 18, 2020 (EP) 20208305.1

(51) Int. Cl. H04L 41/0806; G05B 19/02

(52) U.S. Cl. CPC H04L 41/0806; G05B 19/02; G05B 2219/2642

(57) ABSTRACT

Configuration of a building. A method of configuring a site, the site comprising a plurality of devices (11-23), the plurality of devices (11-23) comprising a plurality of site controllers and a plurality of sensors and a plurality of appliances, the method comprising the steps of: selecting a first device (11-23) from the plurality of appliances and/or from the plurality of sensors; producing first descriptor data for the first device (11-23); selecting a second device (11-23) from the plurality of appliances and/or from the plurality of sensors; producing second descriptor data for the second device (11-23); loading data indicative of an ontology database (9), the ontology database comprising a set of rules; producing relationship data by applying one or more rules to the first and second descriptor data; selecting a third device (11-23) from among the controllers.

### CROSS-REFERENCE TO RELATED APPLICATIONS

This application is a U.S. National Stage Application of International Application No. PCT/EP2021/066347 filed Jun. 17, 2021, which designates the United States of America, and claims priority to EP Application No. 20208305.1 filed Nov. 18, 2020, the contents of which are hereby incorporated by reference in their entirety.

### TECHNICAL FIELD

The present disclosure pertains to configuration and commission a building having a plurality of devices such as controllers, radiators, compressors, evaporators, valves, etc. The configuration process accommodates dependencies between these devices.

### BACKGROUND

Commercial and/or residential and/or industrial sites typically comprise a plurality of appliances such as fans and/or heating fans and/or cooling fans and/or heating coils and/or cooling coils and/or compressors and/or evaporators and/or window blinds and/or radiators and/or chilled beams, etc. Commercial and/or residential and/or industrial sites also comprise a plurality of sensors such as temperature sensors, moisture sensors, luminosity sensors, sensors for volatile organic compounds, sensors for carbon dioxide etc. Readings are recorded from such sensors and those readings impact on the control of the building. A reading recorded from a temperature sensor can, by way of example, be relevant for an amount of cooling provided by a chilled beam inside a space. Likewise, a reading recorded from a luminosity sensor can determine the position of window blinds.

A site and/or a building typically comprises a plurality of controllers. The controllers link sensors such as temperature sensors or luminosity sensors to appliances and/or field devices such as chilled beams or window blinds. Not every controller is, however, compatible with every type of sensor. Likewise, a controller for controlling window blinds may not be suitable to control chilled beams.

A floor plan is established at the design stage and/or at the commissioning stage of a site. The floor plan establishes dependencies between appliances, sensors, and controllers. Creation of a floor plan involves specialist knowledge and numerous hours. The specialist needs to know whether certain devices can be linked to certain sensors. A controller can be required to link a device to a sensor. Also, the link between the appliance and the sensor can necessitate a special type of controller. Eventually, the floor plan will describe the complex relationships between a plethora of appliances and/or sensors and/or controllers of a commercial and/or residential and/or industrial building.

European patent application EP3439235A1 deals with configuring and operating a system with building automation devices. EP3439235A1 describes a method of configuring building automation devices. The building automation devices form a technical system of a building and perform functions related to the building. Configuration according to EP3439235A1 relies on three data structures. The first of these data structures is at a device agnostic level while the second data structure is at a device specific level. The first data structure specifies inter-device communication in a way that is not technology specific. The device-agnostic level generally defines communication in terms of system functions. At the device-agnostic level, functions can, by way of example, turn on and off lights.

Unlike the first data structure, the second data structure specifies inter-device communication during operation in a way that is specific for the devices in the building. Device-specific communication can, by way of example, involve parameters cl to c9 that are specific to building-related functions of devices such as lighting devices.

EP3439235A1 deals with mapping signals at the device-agnostic level to signals at the device-specific level. Configuration settings are then determined that specify how devices communicate. Those configuration settings are transmitted to and applied by the respective building devices.

Patent application US2019/005438A1 describes an automated configuration system for a complex system requiring exhaustive custom programming. US2019/005438A1 discloses a user interface for generating installation details. The user interface involves constraints of virtual devices as well as selectors to apply requirements of such interfaces. Eventually, a control interface is constructed that accounts for details of an installation.

Patent application US2016/095188A1 describes systems and methods for managing environmental conditions.

### SUMMARY

The instant disclosure introduces configuration of devices in a building, wherein the appliances and/or sensors and/or controllers are paired based on a (semantic) ontology description. The configuration based on a (semantic) ontology description mitigates issues due to complexity of floor plans of large buildings. For example, some embodiments include a method of configuring a site, the site comprising a plurality of devices (11-23), the plurality of devices (11-23) comprising a plurality of site controllers and a plurality of sensors and a plurality of appliances, the method comprising: selecting a first device (11-23) from the plurality of appliances and/or from the plurality of sensors; loading a device database, the device database comprising descriptor data for the plurality of appliances and/or for the plurality of sensors; using the device database to produce first descriptor data for the first device (11-23); selecting a second device (11-23) from the plurality of appliances and/or from the plurality of sensors; using the device database to produce second descriptor data for the second device (11-23); loading an ontology database comprising a set of rules applicable to the first device (11-23) and to the second device (11-23); producing relationship data indicative of a relationship between the first device (11-23) and the second device (11-23) by applying at least one of the rules of the set of rules of the ontology database to the first descriptor data and to the second descriptor data; selecting a third device (11-23) from the plurality of site controllers based on the relationship between the first device (11-23) and/or the second device (11-23) as indicated by the relationship data; producing a first set of configuration data based on the relationship between the first device (11-23) and/or the second device (11-23) as indicated by the relationship data; producing a second set of configuration data based on the relationship between the first device (11-23) and/or the second device (11-23) as indicated by the relationship data; producing a third set of configuration data based on the relationship between the first device (11-23) and/or the second device (11-23) as indicated by the relationship data; transmitting the first set of configuration data to the first device (11-23); transmitting the second set of configuration data to the second device (11-23); transmitting the third set of configuration data to the third device (11-23); applying the first set of configuration data to the first device (11-23); applying the second set of configuration data to the second device (11-23); and applying the third set of configuration data to the third device (11-23).

In some embodiments, the method further comprises: selecting the first device (11-23) from the plurality of appliances; producing a first set of appliance configuration data based on the relationship between the first device (11-23) and/or the second device (11-23) as indicated by the relationship data; transmitting the first set of appliance configuration data to the first device (11-23); and applying the first set of appliance configuration data to the first device (11-23), the first device (11-23) thereafter using the first set of appliance configuration data in operation of the first device (11-23).

In some embodiments, the method further comprises: selecting the second device (11-23) from the plurality of sensors; producing a second set of sensor configuration data based on the relationship between the first device (11-23) and/or the second device (11-23) as indicated by the relationship data; transmitting the second set of sensor configuration data to the second device (11-23); and applying the second set of sensor configuration data to the second device (11-23), the second device (11-23) thereafter using the second set of sensor configuration data in operation of the second device (11-23).

In some embodiments, the method further comprises producing the first set of configuration data based on the relationship between the first device (11-23) and/or the second device (11-23) as indicated by the relationship data and based on the first descriptor data.

In some embodiments, the method further comprises producing the first set of configuration data based on the based on the relationship between the first device (11-23) and/or the second device (11-23) as indicated by the relationship data and based on the first descriptor data and based on the second descriptor data.

In some embodiments, the method further comprises using the device database to produce the first descriptor data for the first device (11-23).

In some embodiments, the method further comprises producing the relationship data indicative of a relationship between the first device (11-23) and the second device (11-23) by applying two or more of the rules of the set of rules of the ontology database to the first descriptor data and to the second descriptor data.

In some embodiments, the method further comprises: loading data indicative of a building information model (8) of the site; producing the building information model of the site from the data indicative of the building information model (8) of the site; and producing the relationship data indicative of a relationship between the first device (11-23) and the second device (11-23) by applying the building information model of the site and at least one of the rules of the set of rules of the ontology database to the first descriptor data and to the second descriptor data.

In some embodiments, the method further comprises: loading data indicative of a building information model (8) of the site; producing the building information model of the site from the data indicative of the building information model (8) of the site; producing an extended ontology database comprising a set of rules by merging the ontology database and the building information model of the site; and producing the relationship data indicative of a relationship between the first device (11-23) and the second device (11-23) by applying at least one of the rules of the set of rules of the extended ontology database to the first descriptor data and to the second descriptor data.

In some embodiments, the site comprises a configuration controller (5) having a memory (7) storing the data indicative of the ontology database (9), and the method further comprises: the configuration controller (5) selecting the first device (11-23) from the plurality of appliances and/or from the plurality of sensors; the configuration controller (5) producing the first descriptor data for the first device (11-23); the configuration controller (5) selecting the second device (11-23) from the plurality of appliances and/or from the plurality of sensors; the configuration controller (5) producing the second descriptor data for the second device (11-23); the configuration controller (5) loading data indicative of the ontology database (9) from the memory (7); the configuration controller (5) producing the relationship data by applying at least one of the rules of the set of rules of the ontology database to the first descriptor data and to the second descriptor data; the configuration controller (5) selecting the third device (11-23) from the plurality of site controllers based on the relationship data; the configuration controller (5) producing the third set of configuration data based on the relationship data; the configuration controller (5) transmitting the third set of configuration data to the third device (11-23) using a digital communication bus and a digital communication protocol; and the third device (11-23) applying the third set of configuration data, the third device (11-23) thereafter using the third set of configuration data in operation of the third device (11-23).

In some embodiments, the memory (7) stores data indicative of the building information model (8) of the site, the method comprises: the configuration controller (5) loading the data indicative of the building information model (8) of the site from the memory (7); the configuration controller (5) producing the building information model of the site from the data indicative of the building information model (8) of the site; and the configuration controller (5) producing the relationship data indicative of a relationship between the first device (11-23) and the second device (11-23) by applying the building information model of the site and at least one of the rules of the set of rules of the ontology database to the first descriptor data and to the second descriptor data.

In some embodiments, the method further comprises: the third device (11-23) deriving a set of proportional and integral parameters from the third set of configuration data; and the third device (11-23) thereafter using the set of proportional and integral parameters to perform site control.

As another example, some embodiments include a configuration controller (5) for a site, the site comprising a plurality of devices (11-23), the plurality of devices (11-23) comprising a plurality of site controllers and a plurality of sensors and a plurality of appliances, the configuration controller (5) being configured to: select a first device (11-23) from the plurality of appliances and/or from the plurality of sensors; load a device database, the device database comprising descriptor data for the plurality of appliances and/or for the plurality of sensors; use the device database to produce first descriptor data for the first device (11-23); select a second device (11-23) from the plurality of appliances and/or from the plurality of sensors; use the device database to produce second descriptor data for the second device (11-23); load an ontology database comprising a set of rules applicable to the first device (11-23) and to the second device (11-23); produce relationship data indicative of a relationship between the first device (11-23) and the second device (11-23) by applying at least one of the rules of the set of rules of the ontology database to the first descriptor data and to the second descriptor data; select a third device (11-23) from the plurality of site controllers based on the relationship between the first device (11-23) and/or the second device (11-23) as indicated by the relationship data; produce a first set of configuration data based on the relationship between the first device (11-23) and/or the second device (11-23) as indicated by the relationship data; produce a second set of configuration data based on the relationship between the first device (11-23) and/or the second device (11-23) as indicated by the relationship data; produce a third set of configuration data based on the relationship between the first device (11-23) and/or the second device (11-23) as indicated by the relationship data; transmit the first set of configuration data to the first device (11-23); transmit the second set of configuration data to the second device (11-23); transmit the third set of configuration data to the third device (11-23); apply the first set of configuration data to the first device (11-23); apply the second set of configuration data to the second device (11-23); and apply the third set of configuration data to the third device (11-23).

As another example, some embodiments include a computer program comprising instructions which, when the program is executed by the configuration controller (5) as described herein, cause the configuration controller (5) to carry out any of the methods described herein.

As another example, some embodiments include a computer-readable medium comprising instructions which, when executed by one of the configuration controllers (5) described herein, cause the configuration controller (5) to carry out any of the methods described herein.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 schematically illustrates a device list.

FIG. 2 shows a configuration controller.

FIG. 3 schematically shows a memory storing an ontology database.

FIG. 4 schematically illustrates configuration of various devices of a building.

### DETAILED DESCRIPTION

The instant disclosure describes methods and controllers for configuring a site such as a building. Devices are selected from sensor devices, appliances and controller devices. Descriptor data are produced for such devices. The descriptor data can, by way of non-limiting examples, comprise data about protocols to be used by such devices and/or about addresses to be configured. The descriptor data can also provide data and/or information about the extent to which such devices can be controlled. The descriptor data can further provide data and/or information about control modes. Suitable controllers are selected based on relationships between the sensor devices and the appliance devices. An ontology database is employed to derive such relationships from the descriptor data associated with the devices.

Various embodiments of the teachings of the present disclosure alleviates configuration and commissioning of sites since an ontology database determines relationships between devices to be configured. The ontology database is applied to descriptors of devices and determines whether and how two devices can connect. It follows that relationships and/or links between devices can, at least, be preselected based on the ontology database.

An ontology database can be employed in full or in part to perform configuration and/or commissioning. That is, a set of rules such as semantic json or xml rules can be applied in full or in part to device descriptors to determine and/or suggest relationships between devices.

Generation of descriptor data typically involves a device database. In other words, a device descriptor is selected from a device database for a given device. The device database can, by way of non-limiting example, be a list of devices, the list specifying ports and/or addresses and/or control modes to be employed.

In some embodiments, the relationships and/or the links are additionally determined using a building information model of a site. The building information model can also be a building information model of a commercial and/or industrial and/or residential building. It is envisaged that the building information model and the ontology database determine the relationships and/or the links between the devices. It is also envisaged that an application of the building information model to an ontology database results in an extended ontology database. The extended ontology database can then be leveraged in full or in part to perform configuration and/or commissioning.

Configuration and/or commissioning can thereafter be used by the sensor devices and/or appliances and/or control devices in operation. To that end, configuration data are advantageously transmitted to the devices using a digital bus and a digital protocol. The configuration data are applied to these devices and either by a configuration controller and/or by the devices themselves.

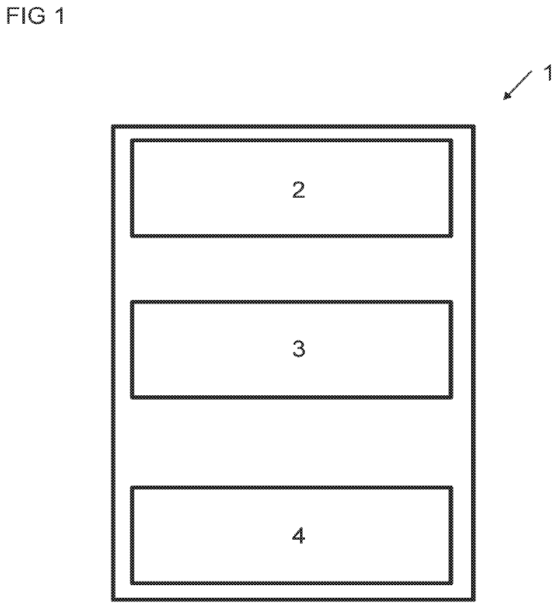

FIG. 1 illustrates a device list 1. The device list 1 comprises at least one list of appliances 2 and/or at least one list of sensors 3 and/or at least one list of controllers 4. The at least one list of appliances and/or field devices 2 can include at least one of
a heating coil and/or
a cooling coil and/or
a compressor and/or
an evaporator and/or
window blinds and/or
a radiator and/or
an expansion valve and/or
an electromagnetic valve and/or
a pressure-independent control valve and/or
a lamp and/or
a chilled beam, etc.

The at least one list of sensors 3 can include at least one of
a temperature sensor and/or
a humidity sensor and/or
a pressure sensor and/or
a luminosity sensor and/or
an infrared light sensor and/or
a sensor for volatile organic compounds and/or
a sensor for carbon dioxide and/or
a noise sensor and/or
a camera such as an infrared camera, etc.

The at least one list of sensors 3 can comprise at least one nonconventional sensor such as a temperature sensor installed inside a smoke detector. The primary purpose of the smoke detector is not to sense temperature. Yet, a smoke detector can deliver data indicative of smoke along with data indicative of temperature. Likewise, a television apparatus can provide an infrared sensor. The primary purpose of a television apparatus is not to sense infrared light. Yet, a television apparatus such as a smart television apparatus can deliver data indicative of television signals along with data indicative of infrared light. The infrared sensor installed inside a television apparatus thus becomes a nonconventional sensor.

At least one list of controllers 4 can also be part of the device list 1. The at least one list of controllers 4 can comprise
a proportional controller and/or
a proportional and integral controller and/or
a proportional and integral and derivative controller and/or
a neural network controller and/or
a fuzzy logic controller and/or
a Bayesian controller and/or
any of the above controllers, wherein the controller is an isolated process executed by a remote controller such as a cloud computer,
a local controller comprising a microprocessor and/or a microcomputer, wherein the microprocessor and/or the microcontroller implements any of the above proportional, proportional and integral, proportional and integral and derivative, neural network, fuzzy logic, Bayesian controllers,
a controller implemented by a (stochastic) quantum computer, etc.

In some embodiments, the controller comprises an inexpensive, low-power system on a chip microcontroller having integrated wireless connectivity. In some embodiments, the chip microcontroller has a memory not exceeding one mebibyte.

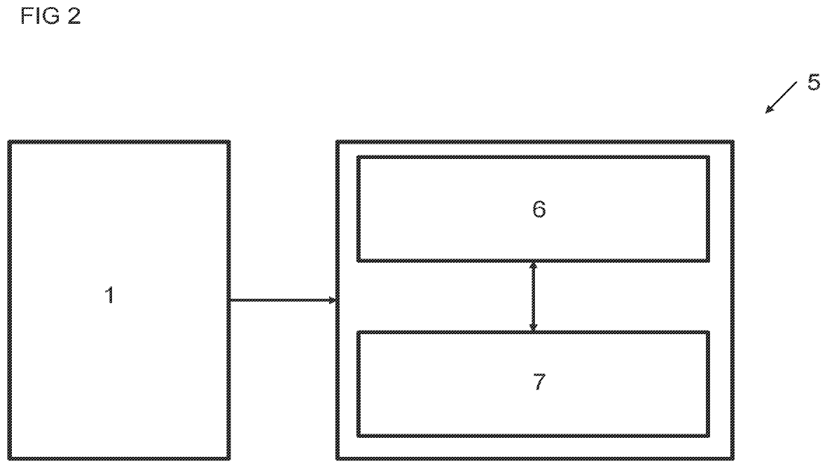

The device list 1 is read and processed by a configuration controller 5 as indicated in FIG. 2. The configuration controller 5 advantageously comprises an arithmetic logic unit 6. The configuration controller 5 also comprises a memory 7 such as a non-volatile memory. In some embodiments, the arithmetic logic unit 6 is in operative communication with the memory 7.

In some embodiments, the configuration controller 5 reads the device list 1 and stores a copy thereof in its memory 7. To that end, the configuration controller 5 has write access to the memory 7. The configuration controller 5 can also read data such as data indicative of the above lists 1-4 from the memory 7.

A connection between the configuration controller 5 and a medium storing the device list 1 can be bidirectional. A bidirectional connection affords flexibility. A connection between the configuration controller 5 and the medium storing the device list 1 can also be unidirectional. More specifically, the connection between the configuration controller 5 and the medium storing the device list 1 can be directed from the device list 1 to the configuration controller 5. A unidirectional connection reduces complexity.

In some embodiments, the memory 7 stores data indicative of a building information model (BIM). The building information model can, by way of non-limiting example, be a building information model of the site and/or a building information model of the building. The building information can, by way of non-limiting example, be a building information model of the commercial and/or residential and/or industrial building.

In some embodiments, the configuration controller 5 and/or the arithmetic logic unit 6 can read the data indicative of a building information model from the memory 7. In some embodiments, the controller 5 reads the data indicative of a building information model from an external computer-readable medium.

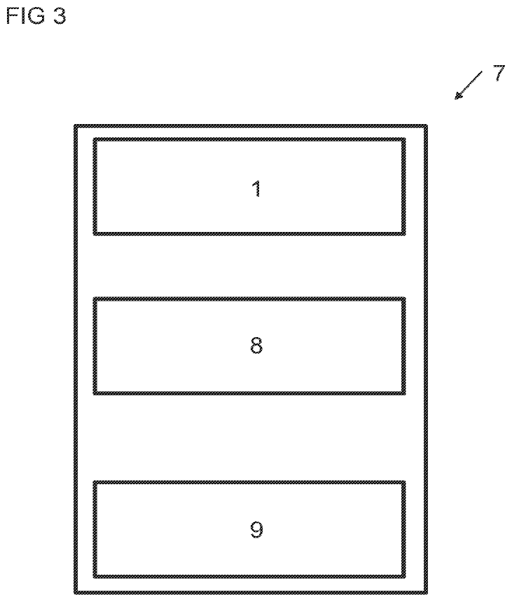

FIG. 3 shows a memory 7 storing a device list 1 and/or data indicative of a building information model 8 and/or data indicative of an ontology database 9. The ontology database provides a set of rules such as a set of semantic rules. These rules describe relationships between the various devices of a commercial and/or residential and/or industrial building. The ontology database 9 can be stored in an extensible markup language (.xml) format and/or in a javascript object notation (.json) format.

In some embodiments, the configuration controller 5 and/or the arithmetic logic unit 6 can read the data indicative of an ontology database 9 from the memory 7. In some embodiments, the controller 5 can read the data indicative of an ontology database 9 from an external computer-readable medium. The configuration controller 5 and/or the arithmetic logic unit 6 can apply one or more of the rules of the ontology database 9 to devices on the device list 1. In some embodiments, the configuration controller 5 and/or the arithmetic logic unit 6 can conflate rules provided by the ontology database 9 and the building information model 8. The configuration controller 5 and/or the arithmetic logic unit 6 can then apply such conflated rules to one or more devices on the device list 7.

In some embodiments, the ontology database 9 comprises an electronic database comprising data that are systematically or methodically arranged and can be individually accessed. In some embodiments, the ontology database 9 is an electronic database comprising data that are systematically or methodically arranged and can be individually accessed.

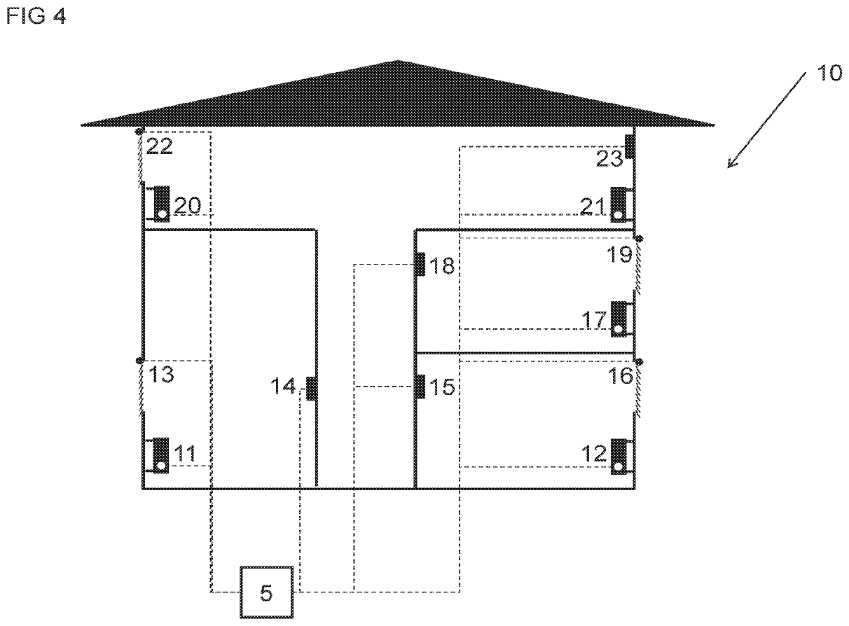

Now turning to FIG. 4, the configuration as previously determined can be applied to various devices 11-23 within a building 10. To that end, the configuration controller 5 needs to connect to the various devices 11-23. A connection between the configuration controller 5 and the devices 11-23 can be bidirectional. A bidirectional connection affords flexibility. A connection between the configuration controller 5 and the medium storing the devices 11-23 can also be unidirectional. More specifically, the connection between the configuration controller 5 and the devices 11-23 can be directed from the configuration controller 5 to one of the devices 11-23. In some embodiments, the configuration controller 5 connects to each device 11-23 via such a unidirectional connection. A unidirectional connection reduces complexity.

Any steps of a method incorporating teachings of the present disclosure can be embodied in hardware and/or in a software module executed by a processor and/or in a software module executed by a processor inside a container using operating system level virtualisation and/or in a cloud computing arrangement, or in a combination thereof. The software may include a firmware and/or a hardware driver run by the operating system and/or or an application program. Thus, the disclosure also relates to a computer program product for performing the operations presented herein. If implemented in software, the functions described may be stored as one or more instructions on a computer-readable medium. Some examples of storage media that can be used include random access memory (RAM) and/or read only memory (ROM) and/or flash memory and/or EPROM memory and/or EEPROM memory and/or registers and/or a hard disk and/or a removable disk and/or other optical disks and/or or any available media that can be accessed by a computer or any other IT equipment and appliance.

As described in detail herein, the instant disclosure deals with methods of configuring a site, the site comprising a plurality of devices (11-23), the plurality of devices (11-23) comprising a plurality of site controllers and a plurality of sensors and a plurality of appliances, the method comprising: selecting a first device (11-23) from the plurality of appliances and/or from the plurality of sensors; producing first descriptor data for the first device (11-23); selecting a second device (11-23) from the plurality of appliances and/or from the plurality of sensors; producing second descriptor data for the second device (11-23); loading data indicative of an ontology database (9), the ontology database comprising a set of rules; producing relationship data by applying at least one of the rules of the set of rules of the ontology database to the first descriptor data and to the second descriptor data; selecting a third device (11-23) from the plurality of site controllers based on the relationship data; producing a first set of configuration data based on the relationship data; producing a second set of configuration data based on the relationship data; producing a third set of configuration data based on the relationship data; transmitting the first set of configuration data to the first device (11-23); transmitting the second set of configuration data to the second device (11-23); transmitting the third set of configuration data to the third device (11-23); applying the first set of configuration data to the first device (11-23); applying the second set of configuration data to the second device (11-23); and applying the third set of configuration data to the third device (11-23).

The present disclosure also describes methods of configuring a site, the site comprising a plurality of devices (11-23), the plurality of devices (11-23) comprising a plurality of site controllers and a plurality of sensors and a plurality of appliances, the method comprising: selecting a first device (11-23) from the plurality of appliances and/or from the plurality of sensors; loading a device database, the device database comprising descriptor data for the plurality of appliances and/or for the plurality of sensors; using the device database to produce first descriptor data for the first device (11-23); selecting a second device (11-23) from the plurality of appliances and/or from the plurality of sensors; using the device database to produce second descriptor data for the second device (11-23); loading an ontology database comprising a set of rules applicable to the first device (11-23) and to the second device (11-23); producing relationship data indicative of a relationship between the first device (11-23) and the second device (11-23) by applying at least one of the rules of the set of rules of the ontology database to the first descriptor data and to the second descriptor data; selecting a third device (11-23) from the plurality of site controllers based on the relationship between the first device (11-23) and/or the second device (11-23) as indicated by the relationship data; producing a first set of configuration data based on the relationship between the first device (11-23) and/or the second device (11-23) as indicated by the relationship data; producing a second set of configuration data based on the relationship between the first device (11-23) and/or the second device (11-23) as indicated by the relationship data; producing a third set of configuration data based on the relationship between the first device (11-23) and/or the second device (11-23) as indicated by the relationship data; transmitting the first set of configuration data to the first device (11-23); transmitting the second set of configuration data to the second device (11-23); transmitting the third set of configuration data to the third device (11-23); applying the first set of configuration data to the first device (11-23); applying the second set of configuration data to the second device (11-23); and applying the third set of configuration data to the third device (11-23).

In some embodiments, the first descriptor data describes one or more intrinsic properties of the first device (11-23). The one or more intrinsic properties can, by way of example, comprise at least one of:
a rated power of the first device (11-23);
a range of operating temperatures of the first device (11-23);
an indication whether the first device (11-23) is battery powered;
a digital or analog communication protocol to be used with the first device (11-23);
a serial number of the first device (11-23);
a type of a physical communication interface of the first device (11-23).

The first descriptor data describes one or more technical properties of the first device (11-23). The one or more technical properties can, by way of example, comprise at least one of:
a rated power of the first device (11-23);
a range of operating temperatures of the first device (11-23);
an indication whether the first device (11-23) is battery powered;
a digital or analog communication protocol to be used with the first device (11-23);
a type of a physical communication interface of the first device (11-23).

In some embodiments, the second descriptor data describes one or more intrinsic properties of the second device (11-23). The one or more intrinsic properties can, by way of example, comprise at least one of:
a rated power of the second device (11-23);
a range of operating temperatures of the second device (11-23);
an indication whether the second device (11-23) is battery powered;
a digital or analog communication protocol to be used with the second device (11-23);
a serial number of the second device (11-23);
a type of a physical communication interface of the second device (11-23).

The second descriptor data describes one or more technical properties of the second device (11-23). The one or more technical properties can, by way of example, comprise at least one of:
a rated power of the second device (11-23);
a range of operating temperatures of the second device (11-23);
an indication whether the second device (11-23) is battery powered;
a digital or analog communication protocol to be used with the second device (11-23);
a type of a physical communication interface of the second device (11-23).

In some embodiments, the method comprises loading a device database, the device database comprising descriptor data for the plurality of appliances and for the plurality of sensors.

In some embodiments, the method comprises loading a device database, the device database comprising descriptor data for the plurality of appliances and for the plurality of sensors and for the plurality of site controllers.

In some embodiments, the method comprises: producing relationship data indicative of a technical relationship between the first device (11-23) and the second device (11-23) by applying at least one of the rules of the set of rules of the ontology database to the first descriptor data and to the second descriptor data; selecting a third device (11-23) from the plurality of site controllers based on the technical relationship between the first device (11-23) and/or the second device (11-23) as indicated by the relationship data; producing a first set of configuration data based on the technical relationship between the first device (11-23) and/or the second device (11-23) as indicated by the relationship data; producing a second set of configuration data based on the technical relationship between the first device (11-23) and/or the second device (11-23) as indicated by the relationship data; and producing a third set of configuration data based on the technical relationship between the first device (11-23) and/or the second device (11-23) as indicated by the relationship data.

In some embodiments, the site is a building (10) such as a commercial and/or residential and/or industrial building. In some embodiments, the site comprises a building (10) such as a commercial and/or residential and/or industrial building.

In some embodiments, the ontology database comprises a set of semantic rules applicable to the first device (11-23) and to the second first device (11-23). In some embodiments, the ontology database comprises a set of semantic rules specifically applicable to the first device (11-23) and to the second first device (11-23). In some embodiments, the ontology database comprises a set of semantic rules applicable to the third device (11-23). In some embodiments, the ontology database comprises a set of semantic rules specifically applicable to the third device (11-23).

In some embodiments, the ontology database comprises a plurality of semantic rules and the relationship data are produced by applying at least one of the semantic rules of the set of semantic rules of the ontology database to the first descriptor data and to the second descriptor data.

In some embodiments, the method comprises loading an ontology database comprising a set of semantic rules applicable to the first device (11-23) and to the second device (11-23).

In some embodiments, the method comprising the step of:
loading an ontology database comprising a set of rules specifically applicable to the first device (11-23) and to the second device (11-23).

In some embodiments, the method comprises loading an ontology database comprising a set of semantic rules specifically applicable to the first device (11-23) and to the second device (11-23).

In some embodiments, the method comprises loading an ontology database comprising a set of semantic rules applicable to the first descriptor data and to the second descriptor data.

In some embodiments, the method comprises loading an ontology database comprising a set of rules specifically applicable to the first descriptor data and to the second descriptor data.

In some embodiments, the method comprises loading an ontology database comprising a set of semantic rules specifically applicable to the first descriptor data and to the second descriptor data.

In some embodiments, the set of rules of the ontology database comprises two or more rules. In some embodiments, the set of rules of the ontology database comprises three or more rules. In some embodiments, the set of rules of the ontology database comprises four or more rules. In some embodiments, the set of rules of the ontology database comprises two or more semantic rules. In some embodiments, the set of rules of the ontology database comprises three or more semantic rules. In some embodiments, the set of rules of the ontology database comprises four or more semantic rules.

In some embodiments, the method comprises: loading data indicative of an ontology database (9), the ontology database comprising a set of rules; and producing the ontology database comprising the set of rules from the data indicative of the ontology database (9).

In some embodiments, the method comprises: loading data indicative of an ontology database (9), the ontology database comprising a set of semantic rules; and producing the ontology database comprising the set of semantic rules from the data indicative of the ontology database (9).

In some embodiments, the method comprises: loading data indicative of an ontology database (9), the ontology database comprising a set of rules; and producing the set of rules of the ontology database from the data indicative of the ontology database (9).

In some embodiments, the method comprises: loading data indicative of an ontology database (9), the ontology database comprising a set of semantic rules; and producing the set of semantic rules of the ontology database from the data indicative of the ontology database (9).

In some embodiments, the method comprises loading an ontology database comprising a set of rules.

In some embodiments, the method comprises loading an ontology database comprising a set of semantic rules.

In some embodiments, the method comprises transmitting the first set of configuration data to the first device (11-23) using a digital communication bus.

In some embodiments, the method comprises transmitting the second set of configuration data to the second device (11-23) using a digital communication bus.

In some embodiments, the method comprises transmitting the third set of configuration data to the third device (11-23) using a digital communication bus.

In some embodiments, the digital communication bus is a wireless, digital communication bus. In some embodiments, the digital communication bus comprises a wireless, digital communication bus. In some embodiments, the digital communication bus is a hardwired, digital communication bus. In some embodiments, the digital communication bus comprises a hardwired, digital communication bus. A wireless communication bus affords flexibility since no devices (11-23) need be plugged in. A hardwired communication bus can enable parallel transmissions of data and of power.

In some embodiments, the method comprises transmitting the first set of configuration data to the first device (11-23) using a digital communication protocol.

In some embodiments, the method comprises transmitting the second set of configuration data to the second device (11-23) using a digital communication protocol.

In some embodiments, the method comprises transmitting the third set of configuration data to the third device (11-23) using a digital communication protocol.

In some embodiments, the digital communication protocol is a connectionless, digital communication protocol. In some embodiments, the digital communication protocol comprises a connectionless, digital communication protocol. In some embodiments, the digital communication protocol is a connection-oriented, digital communication protocol. In some embodiments, the digital communication protocol comprises a connection-oriented, digital communication protocol. Connectionless protocols confer advantages in terms of fast transmission rates. Connection-oriented protocols afford reliable communication.

The relationship data are indicative of a relationship between the first device (11-23) and/or the second device (11-23) and/or the third device (11-23). The relationship data are indicative of a technical relationship between the first device (11-23) and/or the second device (11-23) and/or the third device (11-23). The technical between the first device (11-23) and/or the second device (11-23) and/or the third device (11-23) can, by way of example, indicate technical compatibility between the first device (11-23) and/or the second device (11-23) and/or the third device (11-23). The technical between the first device (11-23) and/or the second device (11-23) and/or the third device (11-23) can, by way of another example, also indicate technical incompatibility between the first device (11-23) and/or the second device (11-23) and/or the third device (11-23). The relationship data can, by way of non-limiting examples, indicate compatible ports of the first device (11-23) and of the second device (11-23) and/or compatible ports of the second device (11-23) and of the third device (11-23) and/or compatible ports of the third device (11-23) and of the first device (11-23). The relationship data can also, by way of non-limiting examples, indicate common communication protocols of the first device (11-23) and of the second device (11-23) and/or common communication protocols of the second device (11-23) and of the third device (11-23) and/or common communication protocols of the third device (11-23) and of the first device (11-23).

In some embodiments, the method comprises: selecting the first device (11-23) from the plurality of appliances; producing a first set of appliance configuration data based on the relationship data; transmitting the first set of appliance configuration data to the first device (11-23); and applying the first set of appliance configuration data to the first device (11-23), the first device (11-23) thereafter using the first set of appliance configuration data in operation of the first device (11-23).

In some embodiments, the method comprises: selecting the first device (11-23) from the plurality of appliances; producing a first set of appliance configuration data based on the relationship between the first device (11-23) and/or the second device (11-23) as indicated by the relationship data; transmitting the first set of appliance configuration data to the first device (11-23); and applying the first set of appliance configuration data to the first device (11-23), the first device (11-23) thereafter using the first set of appliance configuration data in operation of the first device (11-23).

In some embodiments, the method comprises: selecting the second device (11-23) from the plurality of sensors; producing a second set of sensor configuration data based on the relationship data; transmitting the second set of sensor configuration data to the second device (11-23); and applying the second set of sensor configuration data to the second device (11-23), the second device (11-23) thereafter using the second set of sensor configuration data in operation of the second device (11-23).

In some embodiments, the method comprises: selecting the second device (11-23) from the plurality of sensors; producing a second set of sensor configuration data based on the relationship between the first device (11-23) and/or the second device (11-23) as indicated by the relationship data; transmitting the second set of sensor configuration data to the second device (11-23); and applying the second set of sensor configuration data to the second device (11-23), the second device (11-23) thereafter using the second set of sensor configuration data in operation of the second device (11-23).

In some embodiments, the method comprises: producing a third set of controller configuration data based on the relationship data; transmitting the third set of controller configuration data to the third device (11-23); and applying the third set of controller configuration data to the third device (11-23), the third device (11-23) thereafter using the third set of controller configuration data in operation of the third device (11-23).

In some embodiments, the method comprises producing the first set of configuration data based on the relationship data and based on the first descriptor data.

In some embodiments, the method comprises producing the first set of configuration data based on the relationship between the first device (11-23) and/or the second device (11-23) as indicated by the relationship data and based on the first descriptor data.

In some embodiments, the method comprises producing the second set of configuration data based on the relationship data and based on the second descriptor data.

In some embodiments, the method comprises producing the first set of configuration data based on the based on the relationship between the first device (11-23) and/or the second device (11-23) as indicated by the relationship data and based on the first descriptor data and based on the second descriptor data.

In some embodiments, the method comprises: producing third descriptor data for the third device (11-23); and producing the third set of configuration data based on the relationship data and based on the third descriptor data.

In some embodiments, the third descriptor data describes one or more intrinsic properties of the third device (11-23). The one or more intrinsic properties can, by way of example, comprise at least one of:
a rated power of the third device (11-23);
a range of operating temperatures of the third device (11-23);
an indication whether the third device (11-23) is battery powered;
a digital or analog communication protocol to be used with the third device (11-23);
a serial number of the third device (11-23);
a type of a physical communication interface of the third device (11-23).

The third descriptor data advantageously describes one or more technical properties of the third device (11-23). The one or more technical properties can, by way of example, comprise at least one of:
a rated power of the third device (11-23);
a range of operating temperatures of the third device (11-23);
an indication whether the third device (11-23) is battery powered;
a digital or analog communication protocol to be used with the third device (11-23);
a type of a physical communication interface of the third device (11-23).

In some embodiments, the method comprises producing the first set of configuration data based on the relationship data and based on the first descriptor data and based on the second descriptor data.

In some embodiments, the method comprises producing the second set of configuration data based on the relationship data and based on the first descriptor data and based on the second descriptor data.

In some embodiments, the method comprises: producing third descriptor data for the third device (11-23); and producing the first set of configuration data based on the relationship data and based on the first descriptor data and based on the second descriptor data and based on the third descriptor data.

In some embodiments, the method comprises: producing third descriptor data for the third device (11-23); and producing the second set of configuration data based on the relationship data and based on the first descriptor data and based on the second descriptor data and based on the third descriptor data.

In some embodiments, the method comprises: producing third descriptor data for the third device (11-23); and producing the third set of configuration data based on the relationship data and based on the first descriptor data and based on the second descriptor data and based on the third descriptor data.

In some embodiments, the method comprises using the device database to produce the first descriptor data for the first device (11-23).

In some embodiments, the method comprises using the device database to produce the second descriptor data for the second device (11-23).

In some embodiments, the method comprises using the device database to produce third descriptor data for the third device (11-23).

In some embodiments, the method comprises using the device database to produce the third descriptor data for the third device (11-23).

In some embodiments, the method comprises using the device database to select the first descriptor data for the first device (11-23) from the device database.

In some embodiments, the method comprises using the device database to select the second descriptor data for the second device (11-23) from the device database.

In some embodiments, the method comprises using the device database to select third descriptor data for the third device (11-23) from the device database.

In some embodiments, the method comprises using the device database to select the third descriptor data for the third device (11-23) from the device database.

In some embodiments, the device database comprises an electronic database comprising data that are systematically or methodically arranged and can be individually accessed. The device database is an electronic database comprising data that are systematically or methodically arranged and can be individually accessed. In some embodiments, the device database comprises an electronic database comprising device data that are systematically or methodically arranged and can be individually accessed. In some embodiments, the device database is an electronic database comprising device data that are systematically or methodically arranged and can be individually accessed.

In some embodiments, the method comprises producing the relationship data by applying two or more of the rules of the set of rules of the ontology database to the first descriptor data and to the second descriptor data.

In some embodiments, the method comprises producing the relationship data indicative of a relationship between the first device (11-23) and the second device (11-23) by applying two or more of the rules of the set of rules of the ontology database to the first descriptor data and to the second descriptor data.

In some embodiments, the method comprises producing the relationship data by applying all the rules of the set of rules of the ontology database to the first descriptor data and to the second descriptor data.

In some embodiments, the method comprises producing the relationship data by applying the full set of rules of the ontology database to the first descriptor data and to the second descriptor data.

In some embodiments, the method comprises producing the relationship data by applying two or more of the semantic rules of the set of semantic rules of the ontology database to the first descriptor data and to the second descriptor data.

In some embodiments, the method comprises producing the relationship data by applying all the semantic rules of the set of semantic rules of the ontology database to the first descriptor data and to the second descriptor data.

In some embodiments, the method comprises producing the relationship data by applying the full set of semantic rules of the ontology database to the first descriptor data and to the second descriptor data.

In some embodiments, the method comprises: loading data indicative of a building information model (8) of the site; producing the building information model of the site from the data indicative of the building information model (8) of the site; and producing the relationship data by applying the building information model of the site and at least one of the rules of the set of rules of the ontology database to the first descriptor data and to the second descriptor data.

In some embodiments, the method comprises: loading data indicative of a building information model (8) of the site; producing the building information model of the site from the data indicative of the building information model (8) of the site; and producing the relationship data indicative of a relationship between the first device (11-23) and the second device (11-23) by applying the building information model of the site and at least one of the rules of the set of rules of the ontology database to the first descriptor data and to the second descriptor data.

In some embodiments, the data indicative of a building information model (8) of the site follow at least one of the standards:
National Building Information Modeling Standard for the United States of America, published on 18 Dec. 2007, version 2 and/or
National Building Information Modeling Standard for the United States of America, published in 2015, version 3 and/or
BIM-reference for Germany, file reference 10.08.17.7-12.08, published in 2013 and/or
British Standard 8536-2:2016 and/or
ÖNORM A 6241-2:2015.

In some embodiments, the building information model of the site follows at least one of the standards:
National Building Information Modeling Standard for the United States of America, published on 18 Dec. 2007, version 2 and/or
National Building Information Modeling Standard for the United States of America, published in 2015, version 3 and/or
BIM-reference for Germany, file reference 10.08.17.7-12.08, published in 2013 and/or
British Standard 8536-2:2016 and/or
ÖNORM A 6241-2:2015.

In some embodiments, the method comprises: loading data indicative of a building information model (8) of the site; producing the building information model of the site from the data indicative of the building information model (8) of the site; and producing the relationship data by applying the building information model of the site and two or more of the rules of the set of rules of the ontology database to the first descriptor data and to the second descriptor data.

In some embodiments, the method comprises: loading data indicative of a building information model (8) of the site; producing the building information model of the site from the data indicative of the building information model (8) of the site; and producing the relationship data by applying the building information model of the site and all the rules of the ontology database to the first descriptor data and to the second descriptor data.

In some embodiments, the method comprises: loading data indicative of a building information model (8) of the site; producing the building information model of the site from the data indicative of the building information model (8) of the site; and producing the relationship data by applying the building information model of the site and the full set of rules of the ontology database to the first descriptor data and to the second descriptor data.

In some embodiments, the method comprises: loading data indicative of a building information model (8) of the site; producing the building information model of the site from the data indicative of the building information model (8) of the site; and producing the relationship data by applying the building information model of the site and at least one of the semantic rules of the ontology database to the first descriptor data and to the second descriptor data.

In some embodiments, the method comprises: loading data indicative of a building information model (8) of the site; producing the building information model of the site from the data indicative of the building information model (8) of the site; and producing the relationship data by applying the building information model of the site and two or more of the semantic rules of the ontology database to the first descriptor data and to the second descriptor data.

In some embodiments, the method comprises: loading data indicative of a building information model (8) of the site; producing the building information model of the site from the data indicative of the building information model (8) of the site; and producing the relationship data by applying the building information model of the site and all the semantic rules of the set of semantic rules of the ontology database to the first descriptor data and to the second descriptor data.

In some embodiments, the method comprises: loading data indicative of a building information model (8) of the site; producing the building information model of the site from the data indicative of the building information model (8) of the site; and producing the relationship data by applying the building information model of the site and the full set of semantic rules of the ontology database to the first descriptor data and to the second descriptor data.

In some embodiments, the method comprises: loading data indicative of a building information model (8) of the site; producing the building information model of the site from the data indicative of the building information model (8) of the site; producing an extended ontology database comprising a set of rules by merging the ontology database and the building information model of the site; and producing the relationship data by applying at least one of the rules of the set of rules of the extended ontology database to the first descriptor data and to the second descriptor data.

In some embodiments, the method comprises: loading data indicative of a building information model (8) of the site; producing the building information model of the site from the data indicative of the building information model (8) of the site; producing an extended ontology database comprising a set of rules by merging the ontology database and the building information model of the site; and producing the relationship data indicative of a relationship between the first device (11-23) and the second device (11-23) by applying at least one of the rules of the set of rules of the extended ontology database to the first descriptor data and to the second descriptor data.

In some embodiments, the building information model of the site is a building information model of a building (10). In some embodiments, the building information model of the site is a building information model of a commercial and/or residential and/or industrial building.

In some embodiments, the set of rules of the extended ontology database comprises two or more rules. In some embodiments, the set of rules of the extended ontology database comprises three or more rules. In some embodiments, the set of rules of the extended ontology database comprises four or more rules. In some embodiments, the set of rules of the extended ontology database comprises two or more semantic rules. In some embodiments, the set of rules of the extended ontology database comprises three or more semantic rules. In some embodiments, the set of rules of the extended ontology database comprises four or more semantic rules.

In some embodiments, the extended ontology database comprises an electronic database comprising data that are systematically or methodically arranged and can be individually accessed. In some embodiments, the extended ontology database is an electronic database comprising data that are systematically or methodically arranged and can be individually accessed.

In some embodiments, the method comprises: loading data indicative of a building information model (8) of the site; producing the building information model of the site from the data indicative of the building information model (8) of the site; producing an extended ontology database comprising a set of rules by merging the ontology database and the building information model of the site; and producing the relationship data by applying two or more of the rules of the set of rules of the extended ontology database to the first descriptor data and to the second descriptor data.

In some embodiments, the method comprises: loading data indicative of a building information model (8) of the site; producing the building information model of the site from the data indicative of the building information model (8) of the site; producing an extended ontology database comprising a set of rules by merging the ontology database and the building information model of the site; and producing the relationship data by applying all the rules of the set of rules of the extended ontology database to the first descriptor data and to the second descriptor data.

In some embodiments, the method comprises: loading data indicative of a building information model (8) of the site; producing the building information model of the site from the data indicative of the building information model (8) of the site; producing an extended ontology database comprising a set of rules by merging the ontology database and the building information model of the site; and producing the relationship data by applying the full set of rules of the extended ontology database to the first descriptor data and to the second descriptor data.

In some embodiments, the method comprises: loading data indicative of a building information model (8) of the site; producing the building information model of the site from the data indicative of the building information model (8) of the site; producing an extended ontology database comprising a set of semantic rules by merging the ontology database and the building information model of the site; and producing the relationship data by applying at least one of the semantic rules of the set of semantic rules of the extended ontology database to the first descriptor data and to the second descriptor data.

In some embodiments, the method comprises: loading data indicative of a building information model (8) of the site; producing the building information model of the site from the data indicative of the building information model (8) of the site; producing an extended ontology database comprising a set of semantic rules by merging the ontology database and the building information model of the site; and producing the relationship data by applying two or more of the semantic rules of the set of semantic rules of the extended ontology database to the first descriptor data and to the second descriptor data.

In some embodiments, the method comprises: loading data indicative of a building information model (8) of the site; producing the building information model of the site from the data indicative of the building information model (8) of the site; producing an extended ontology database comprising a set of semantic rules by merging the ontology database and the building information model of the site; and producing the relationship data by applying all the semantic rules of the set of semantic rules of the extended ontology database to the first descriptor data and to the second descriptor data.

In some embodiments, the method comprises: loading data indicative of a building information model (8) of the site; producing the building information model of the site from the data indicative of the building information model (8) of the site; producing an extended ontology database comprising a set of semantic rules by merging the ontology database and the building information model of the site; and producing the relationship data by applying the full set of semantic rules of the extended ontology database to the first descriptor data and to the second descriptor data.

In some embodiments, the method comprises: the configuration controller (5) selecting the first device (11-23) from the plurality of appliances and/or from the plurality of sensors; the configuration controller (5) producing the first descriptor data for the first device (11-23); the configuration controller (5) selecting the second device (11-23) from the plurality of appliances and/or from the plurality of sensors; the configuration controller (5) producing the second descriptor data for the second device (11-23); the configuration controller (5) loading data indicative of the ontology database (9) from the memory (7); the configuration controller (5) producing the relationship data by applying at least one of the rules of the set of rules of the ontology database to the first descriptor data and to the second descriptor data; the configuration controller (5) selecting the third device (11-23) from the plurality of site controllers based on the relationship data; the configuration controller (5) producing the third set of configuration data based on the relationship data; the configuration controller (5) transmitting the third set of configuration data to the third device (11-23) using a digital communication bus and a digital communication protocol; and the third device (11-23) applying the third set of configuration data, the third device (11-23) thereafter using the third set of configuration data in operation of the third device (11-23).

In some embodiments, the method comprises the configuration controller (5) producing the relationship data by applying two or more rules of the set of rules of the ontology database to the first descriptor data and to the second descriptor data.

In some embodiments, the method comprises the configuration controller (5) producing the relationship data by applying all the rules of the set of rules of the ontology database to the first descriptor data and to the second descriptor data.

In some embodiments, the method comprises the configuration controller (5) producing the relationship data by applying the full set of rules of the ontology database to the first descriptor data and to the second descriptor data.

In some embodiments, the method comprises the configuration controller (5) producing the relationship data by applying two or more semantic rules of the set of semantic rules of the ontology database to the first descriptor data and to the second descriptor data.

In some embodiments, the method comprises the configuration controller (5) producing the relationship data by applying all the semantic rules of the set of semantic rules of the ontology database to the first descriptor data and to the second descriptor data.

In some embodiments, the method comprises the configuration controller (5) producing the relationship data by applying the full set of semantic rules of the ontology database to the first descriptor data and to the second descriptor data.

In some embodiments, the method comprises: the configuration controller (5) loading the data indicative of the building information model (8) of the site from the memory (7); the configuration controller (5) producing the building information model of the site from the data indicative of the building information model (8) of the site; and the configuration controller (5) producing the relationship data by applying the building information model of the site and at least one of the rules of the set of rules of the ontology database to the first descriptor data and to the second descriptor data.

In some embodiments, the method comprises: the configuration controller (5) loading the data indicative of the building information model (8) of the site from the memory (7); the configuration controller (5) producing the building information model of the site from the data indicative of the building information model (8) of the site; and the configuration controller (5) producing the relationship data indicative of a relationship between the first device (11-23) and the second device (11-23) by applying the building information model of the site and at least one of the rules of the set of rules of the ontology database to the first descriptor data and to the second descriptor data.

In some embodiments, the method comprises: the configuration controller (5) loading the data indicative of the building information model (8) of the site from the memory (7); the configuration controller (5) producing the building information model of the site from the data indicative of the building information model (8) of the site; and the configuration controller (5) producing the relationship data by applying the building information model of the site and two or more rules of the set of rules of the ontology database to the first descriptor data and to the second descriptor data.

In some embodiments, the method comprises: the configuration controller (5) loading the data indicative of the building information model (8) of the site from the memory (7); the configuration controller (5) producing the building information model of the site from the data indicative of the building information model (8) of the site; and the configuration controller (5) producing the relationship data by applying the building information model of the site and all the rules of the set of rules of the ontology database to the first descriptor data and to the second descriptor data.

In some embodiments, the method comprises: the configuration controller (5) loading the data indicative of the building information model (8) of the site from the memory (7); the configuration controller (5) producing the building information model of the site from the data indicative of the building information model (8) of the site; and the configuration controller (5) producing the relationship data by applying the building information model of the site and the full set of rules of the ontology database to the first descriptor data and to the second descriptor data.

In some embodiments, a memory (7) stores data indicative of the building information model (8) and the method involves an ontology database comprising a set of semantic rules and the method involves a configuration controller (5).

In some embodiments, the method comprises: the configuration controller (5) loading the data indicative of the building information model (8) of the site from the memory (7); the configuration controller (5) producing the building information model of the site from the data indicative of the building information model (8) of the site; and the configuration controller (5) producing the relationship data by applying the building information model of the site and at least one of the semantic rules of the set of semantic rules of the ontology database to the first descriptor data and to the second descriptor data.

In some embodiments, a memory (7) stores data indicative of the building information model (8) and the method involves an ontology database comprising a set of semantic rules and the method involves a configuration controller (5). In some embodiments, the method comprises: the configuration controller (5) loading the data indicative of the building information model (8) of the site from the memory (7); the configuration controller (5) producing the building information model of the site from the data indicative of the building information model (8) of the site; and the configuration controller (5) producing the relationship data by applying the building information model of the site and two or more semantic rules of the set of semantic rules of the ontology database to the first descriptor data and to the second descriptor data.

In some embodiments, a memory (7) stores data indicative of the building information model (8) and the method involves an ontology database comprising a set of semantic rules and the method involves a configuration controller (5). In some embodiments, the method comprises: the configuration controller (5) loading the data indicative of the building information model (8) of the site from the memory (7); the configuration controller (5) producing the building information model of the site from the data indicative of the building information model (8) of the site; and the configuration controller (5) producing the relationship data by applying the building information model of the site and all the semantic rules of the set of semantic rules of the ontology database to the first descriptor data and to the second descriptor data.

In some embodiments, a memory (7) stores data indicative of the building information model (8) and the method involves an ontology database comprising a set of semantic rules and the method involves a configuration controller (5). In some embodiments, the method comprises: the configuration controller (5) loading the data indicative of the building information model (8) of the site from the memory (7); the configuration controller (5) producing the building information model of the site from the data indicative of the building information model (8) of the site; and the configuration controller (5) producing the relationship data by applying the building information model of the site and the full set of sematic rules of the ontology database to the first descriptor data and to the second descriptor data.

In some embodiments, the method comprises: the third device (11-23) deriving a set of proportional and integral parameters from the third set of configuration data; and the third device (11-23) thereafter using the set of proportional and integral parameters to perform site control.

In some embodiments, the method comprises: the third device (11-23) deriving a set of proportional and integral and derivative parameters from the third set of configuration data; and the third device (11-23) thereafter using the set of proportional and integral and derivative parameters to perform site control.

In some embodiments, the method comprises: the third device (11-23) deriving a set of proportional and integral parameters from the third set of configuration data; and the third device (11-23) thereafter using the set of proportional and integral parameters to perform energy control at the site.

In some embodiments, the method comprises: the third device (11-23) deriving a set of proportional and integral parameters from the third set of configuration data; and the third device (11-23) thereafter using the set of proportional and integral parameters to perform power control at the site.

In some embodiments, the method comprises: the third device (11-23) deriving a set of proportional and integral parameters from the third set of configuration data; and the third device (11-23) thereafter using the set of proportional and integral parameters to perform temperature control at the site.

In some embodiments, the method comprises: the third device (11-23) deriving a set of proportional and integral and derivative parameters from the third set of configuration data; and the third device (11-23) thereafter using the set of proportional and integral and derivative parameters to perform energy control at the site.

In some embodiments, the method comprises: the third device (11-23) deriving a set of proportional and integral and derivative parameters from the third set of configuration data; and the third device (11-23) thereafter using the set of proportional and integral and derivative parameters to perform power control at the site.

In some embodiments, the method comprises: the third device (11-23) deriving a set of proportional and integral and derivative parameters from the third set of configuration data; and the third device (11-23) thereafter using the set of proportional and integral and derivative parameters to perform temperature control at the site.

Some embodiments include application of any of the methods described herein to configure a building (10) such as a commercial and/or residential and/or industrial building.

Some embodiments include a configuration controller (5) for a site, the site comprising a plurality of devices (11-23), the plurality of devices (11-23) comprising a plurality of site controllers and a plurality of sensors and a plurality of appliances, the configuration controller (5) being configured to: select a first device (11-23) from the plurality of appliances and/or from the plurality of sensors; produce first descriptor data for the first device (11-23); select a second device (11-23) from the plurality of appliances and/or from the plurality of sensors; produce second descriptor data for the second device (11-23); load data indicative of an ontology database (9), the ontology database comprising a set of rules; produce the set of rules of the ontology database from the data indicative of the ontology database (9); produce relationship data by applying at least one of the rules of the set of rules of the ontology database to the first descriptor data and to the second descriptor data; select a third device (11-23) from the plurality of site controllers based on the relationship data; produce a first set of configuration data based on the relationship data; produce a second set of configuration data based on the relationship data; produce a third set of configuration data based on the relationship data; transmit the first set of configuration data to the first device (11-23); transmit the second set of configuration data to the second device (11-23); transmit the third set of configuration data to the third device (11-23); apply the first set of configuration data to the first device (11-23); apply the second set of configuration data to the second device (11-23); and apply the third set of configuration data to the third device (11-23).

Some embodiments include a configuration controller (5) for a site, the site comprising a plurality of devices (11-23), the plurality of devices (11-23) comprising a plurality of site controllers and a plurality of sensors and a plurality of appliances, the configuration controller (5) being configured to: select a first device (11-23) from the plurality of appliances and/or from the plurality of sensors; load a device database, the device database comprising descriptor data for the plurality of appliances and/or for the plurality of sensors; use the device database to produce first descriptor data for the first device (11-23); select a second device (11-23) from the plurality of appliances and/or from the plurality of sensors; use the device database to produce second descriptor data for the second device (11-23); load an ontology database comprising a set of rules applicable to the first device (11-23) and to the second device (11-23); produce relationship data indicative of a relationship between the first device (11-23) and the second device (11-23) by applying at least one of the rules of the set of rules of the ontology database to the first descriptor data and to the second descriptor data; select a third device (11-23) from the plurality of site controllers based on the relationship between the first device (11-23) and/or the second device (11-23) as indicated by the relationship data; produce a first set of configuration data based on the relationship between the first device (11-23) and/or the second device (11-23) as indicated by the relationship data; produce a second set of configuration data based on the relationship between the first device (11-23) and/or the second device (11-23) as indicated by the relationship data; produce a third set of configuration data based on the relationship between the first device (11-23) and/or the second device (11-23) as indicated by the relationship data; transmit the first set of configuration data to the first device (11-23); transmit the second set of configuration data to the second device (11-23); transmit the third set of configuration data to the third device (11-23); apply the first set of configuration data to the first device (11-23); apply the second set of configuration data to the second device (11-23); and apply the third set of configuration data to the third device (11-23).

In some embodiments, the configuration controller being configured to load an ontology database comprising a set of semantic rules applicable to the first device (11-23) and to the second device (11-23).

In some embodiments, the configuration controller being configured to load an ontology database comprising a set of rules specifically applicable to the first device (11-23) and to the second device (11-23).

In some embodiments, the configuration controller being configured to load an ontology database comprising a set of semantic rules specifically applicable to the first device (11-23) and to the second device (11-23).

In some embodiments, the configuration controller being configured to load an ontology database comprising a set of semantic rules applicable to the first descriptor data and to the second descriptor data.

In some embodiments, the configuration controller being configured to load an ontology database comprising a set of rules specifically applicable to the first descriptor data and to the second descriptor data.

In some embodiments, the configuration controller being configured to load an ontology database comprising a set of semantic rules specifically applicable to the first descriptor data and to the second descriptor data.

Some embodiments include a use of any of the configuration controllers (5) described herein to configure a building (10) such as a commercial and/or residential and/or industrial building.

In some embodiments, the configuration controller (5) comprises a memory (7) storing data indicative of an ontology database (9), the configuration controller (5) being configured to load data indicative of the ontology database (9) from the memory (7).

In some embodiments, the configuration controller (5) comprises a memory (7) storing data indicative of the building information model (8) of the site, the configuration controller (5) being configured to load the data indicative of the building information model (8) of the site from the memory (7).

In some embodiments, the configuration controller (5) comprises a microcontroller and/or a microprocessor. In some embodiments, the site controller comprises a microcontroller and/or a microprocessor. In some embodiments, the configuration controller (5) for the site is a configuration controller (5) for a plurality of devices (11-23) of a site.

In some embodiments, the configuration controller (5) being configured to load a device database, the device database comprising descriptor data for the plurality of appliances and for the plurality of sensors.

In some embodiments, the configuration controller (5) being configured to load a device database, the device database comprising descriptor data for the plurality of appliances and for the plurality of sensors and for the plurality of site controllers.

In some embodiments, the configuration controller (5) being configured to: produce relationship data indicative of a technical relationship between the first device (11-23) and the second device (11-23) by applying at least one of the rules of the set of rules of the ontology database to the first descriptor data and to the second descriptor data; select a third device (11-23) from the plurality of site controllers based on the technical relationship between the first device (11-23) and/or the second device (11-23) as indicated by the relationship data; produce a first set of configuration data based on the technical relationship between the first device (11-23) and/or the second device (11-23) as indicated by the relationship data; produce a second set of configuration data based on the technical relationship between the first device (11-23) and/or the second device (11-23) as indicated by the relationship data; and produce a third set of configuration data based on the technical relationship between the first device (11-23) and/or the second device (11-23) as indicated by the relationship data.

In some embodiments, the a computer program is executed by a configuration controller (5) as described herein, cause the configuration controller (5) to carry out the steps of any of the methods described herein. In some embodiments, the computer program product comprises instructions which, when the program is executed by a processor such as a general-purpose processor, cause the processor to carry out the steps of any of the methods described herein.

In some embodiments, a computer-readable storage medium stores instructions which, when the program is executed by a configuration controller (5) as described herein, cause the configuration controller (5) to carry out the steps of any of the methods described herein.

In some embodiments, a computer-readable storage medium stores instructions which, when the program is executed by a processor such as a general-purpose processor, cause the processor to carry out the steps of any of the methods described herein.

In some embodiments, the aforementioned computer-readable storage media are tangible. The aforementioned computer-readable storage media non-transitory.

It should be understood that the foregoing relates only to certain embodiments of the disclosure and that numerous changes can be made therein without departing from the scope of the disclosure as defined by the following claims. It should also be understood that the disclosure is not restricted to the illustrated embodiments and that various modifications can be made within the scope of the disclosure.

### REFERENCE NUMERALS

1 device list
2 list of appliances
3 list of sensors
4 list of controllers
5 configuration controller
6 arithmetic logic unit
7 memory
8 data indicative of a building information model
9 data indicative of an ontology database
10 building
11-23 devices

What is claimed is:

1. A method of configuring a site comprising a plurality of devices including a plurality of site controllers, a plurality of sensors, and a plurality of appliances, the method comprising:
selecting a first device from the plurality of appliances and/or the plurality of sensors;
loading a device database comprising descriptor data for the plurality of appliances and/or for the plurality of sensors;
using the device database to produce first descriptor data for the first device;
selecting a second device from the plurality of appliances and/or from the plurality of sensors;
using the device database to produce second descriptor data for the second device;
loading an ontology database comprising a set of rules applicable to the first device and to the second device;
producing relationship data indicative of a relationship between the first device and the second device by applying at least one of the rules of the set of rules of the ontology database to the first descriptor data and to the second descriptor data;
selecting a third device from the plurality of site controllers based on the relationship between the first device and/or the second device as indicated by the relationship data;
producing a first set of configuration data based on the relationship between the first device and/or the second device as indicated by the relationship data;
producing a second set of configuration data based on the relationship between the first device and/or the second device as indicated by the relationship data;
producing a third set of configuration data based on the relationship between the first device and/or the second device as indicated by the relationship data;
transmitting the first set of configuration data to the first device;
transmitting the second set of configuration data to the second device;
transmitting the third set of configuration data to the third device;
applying the first set of configuration data to the first device;
applying the second set of configuration data to the second device; and
applying the third set of configuration data to the third device.

2. The method according to claim 1, the method further comprising:
selecting the first device from the plurality of appliances;
producing a first set of appliance configuration data based on the relationship between the first device and/or the second device as indicated by the relationship data;
transmitting the first set of appliance configuration data to the first device; and
applying the first set of appliance configuration data to the first device, the first device thereafter using the first set of appliance configuration data in operation of the first device.

3. The method according to claim 1, the method further comprises:
selecting the second device from the plurality of sensors;
producing a second set of sensor configuration data based on the relationship between the first device and/or the second device as indicated by the relationship data;
transmitting the second set of sensor configuration data to the second device; and
applying the second set of sensor configuration data to the second device, the second device thereafter using the second set of sensor configuration data in operation of the second device.

4. The method according to claim 1, the method comprising
producing the first set of configuration data based on the relationship between the first device and/or the second device as indicated by the relationship data and based on the first descriptor data.

5. The method according to claim 1, further comprising
producing the first set of configuration data based on the based on the relationship between the first device and/or the second device as indicated by the relationship data and based on the first descriptor data and based on the second descriptor data.

6. The method according to claim 1, further comprising
using the device database to produce the first descriptor data for the first device.

7. The method according to claim 1, further comprising
producing the relationship data indicative of a relationship between the first device and the second device by applying two or more of the rules of the set of rules of the ontology database to the first descriptor data and to the second descriptor data.

8. The method according to claim 1, further comprising:
loading data indicative of a building information model of the site;
producing the building information model of the site from the data indicative of the building information model of the site; and
producing the relationship data indicative of a relationship between the first device and the second device by applying the building information model of the site and at least one of the rules of the set of rules of the ontology database to the first descriptor data and to the second descriptor data.

9. The method according to claim 1, further comprising:
loading data indicative of a building information model of the site;
producing the building information model of the site from the data indicative of the building information model of the site;
producing an extended ontology database comprising a set of rules by merging the ontology database and the building information model of the site; and
producing the relationship data indicative of a relationship between the first device and the second device by applying at least one of the rules of the set of rules of the extended ontology database to the first descriptor data and to the second descriptor data.

10. The method according to claim 1, the site comprising a configuration controller having a memory storing the data indicative of the ontology database, the method further comprising:
the configuration controller selecting the first device from the plurality of appliances and/or from the plurality of sensors;
the configuration controller producing the first descriptor data for the first device;
the configuration controller selecting the second device from the plurality of appliances and/or from the plurality of sensors;
the configuration controller producing the second descriptor data for the second device;
the configuration controller loading data indicative of the ontology database from the memory;
the configuration controller producing the relationship data by applying at least one of the rules of the set of rules of the ontology database to the first descriptor data and to the second descriptor data;
the configuration controller selecting the third device from the plurality of site controllers based on the relationship data;
the configuration controller producing the third set of configuration data based on the relationship data;
the configuration controller transmitting the third set of configuration data to the third device using a digital communication bus and a digital communication protocol; and
the third device applying the third set of configuration data, the third device thereafter using the third set of configuration data in operation of the third device.

11. The method according to claim 10, the memory storing data indicative of the building information model of the site, the method further comprises:
the configuration controller loading the data indicative of the building information model of the site from the memory;
the configuration controller producing the building information model of the site from the data indicative of the building information model of the site; and
the configuration controller producing the relationship data indicative of a relationship between the first device and the second device by applying the building information model of the site and at least one of the rules of the set of rules of the ontology database to the first descriptor data and to the second descriptor data.

12. The method according to claim 1, further comprising:
the third device deriving a set of proportional and integral parameters from the third set of configuration data; and
the third device thereafter using the set of proportional and integral parameters to perform site control.

13. A configuration controller for a site comprising a plurality of devices comprising a plurality of site controllers and a plurality of sensors and a plurality of appliances, the configuration controller configured to:
select a first device from the plurality of appliances and/or from the plurality of sensors;
load a device database, the device database comprising descriptor data for the plurality of appliances and/or for the plurality of sensors;
use the device database to produce first descriptor data for the first device;
select a second device from the plurality of appliances and/or from the plurality of sensors;
use the device database to produce second descriptor data for the second device;
load an ontology database comprising a set of rules applicable to the first device and to the second device;
produce relationship data indicative of a relationship between the first device and the second device by applying at least one of the rules of the set of rules of the ontology database to the first descriptor data and to the second descriptor data;
select a third device from the plurality of site controllers based on the relationship between the first device and/or the second device as indicated by the relationship data;
produce a first set of configuration data based on the relationship between the first device and/or the second device as indicated by the relationship data;
produce a second set of configuration data based on the relationship between the first device and/or the second device as indicated by the relationship data;
produce a third set of configuration data based on the relationship between the first device and/or the second device as indicated by the relationship data;
transmit the first set of configuration data to the first device;
transmit the second set of configuration data to the second device;
transmit the third set of configuration data to the third device;
apply the first set of configuration data to the first device;
apply the second set of configuration data to the second device; and
apply the third set of configuration data to the third device.

14-15. (canceled)
